(19) United States
(12) Patent Application Publication
(10) Pub. No.: US 2026/0144337 A1
(43) Pub. Date: May 28, 2026

(54) QUICK RELEASE AND ASSEMBLE MODULE FOR SHOE MAKING MACHINE

(71) Applicant: POU CHEN CORPORATION, Chang Hwa Hsien (TW)

(72) Inventors: Wen-Pao CHANG, Chang Hwa Hsien (TW); Peng-Jen KUNG, Taipei (TW); Chien-Yu HSU, Chang Hwa Hsien (TW)

(73) Assignee: POU CHEN CORPORATION, Chang Hwa Hsien (TW)

(21) Appl. No.: 19/047,956

(22) Filed: Feb. 7, 2025

(30) Foreign Application Priority Data
Nov. 28, 2024 (TW) 113145952

(51) Int. Cl. A43D 119/00

(52) U.S. Cl. CPC A43D 119/00

(57) ABSTRACT

A quick release and assemble module for a shoe making machine includes a mount seat, a fastener unit, and a brush unit. The mount seat defines an accommodating space and includes a main portion, a bottom portion, and an engage portion and a side portion extending upwardly from the bottom portion and connected to the main portion. The engage portion has an engage groove in spatial communication with the accommodating space and opening upward. The fastener unit includes a fixed member disposed on the main portion, and a latch member pivotably connected to the fixed member. The brush unit includes a brush seat member, and a bristle member disposed on the brush seat member. The brush seat member includes a brush body portion connected to the mount seat by the latch member, and a strip portion connected to the brush body portion and detachably engaging the engage groove.

### CROSS-REFERENCE TO RELATED APPLICATION

This application claims priority to Taiwanese Invention Patent Application No. 113145952, filed on Nov. 28, 2024, the entire disclosure of which is incorporated by reference herein.

### FIELD

The disclosure relates to a module for making shoes, and more particularly to a quick release and assemble module for a shoe making machine.

### BACKGROUND

In a manufacturing process of a conventional shoe making machine, an adhesive is applied on a shoe upper to adhere the shoe upper to a sole. Generally, a robotic arm is connected to a brush for applying the adhesive and drives the brush to apply the adhesive on the shoe upper. To prevent the brush from falling off during use, the brush is usually fixedly connected to the robotic arm by some screws.

However, to manufacture a variety of shoe types by using the conventional shoe making machine, different brushes for various shoe types are required for applying the adhesive thereon. Thus, it is necessary to replace the brushes accordingly, which is troublesome and labor-intensive.

### SUMMARY

Therefore, an object of the present disclosure is to provide a quick release and assemble module for a shoe making machine that can alleviate at least one of the drawbacks of the prior art.

According to an aspect of the disclosure, a quick release and assemble module adapted to be used in a shoe making machine is provided. The quick release and assemble module includes a mount seat, at least one fastener unit, and a brush unit. The mount seat includes a main portion adapted to be mounted to the shoe making machine, a bottom portion extending in an extending direction from one side of the main portion opposite to the shoe making machine in the extending direction and elongated in a horizontal direction transverse to the extending direction, an engage portion extending upwardly in an up-down direction that is transverse to the horizontal direction and the extending direction from one side of the bottom portion in the horizontal direction and connected to the main portion, and a side portion extending upwardly in the up-down direction from another side of the bottom portion in the horizontal direction and connected to the main portion. The main portion, the bottom portion, the engage portion and the side portion cooperatively define an accommodating space that is open in a direction opposite to the shoe making machine in the extending direction. The engage portion has an engage groove in spatial communication with the accommodating space, extending in the up-down direction, and opening upward. The at least one fastener unit includes a fixed member disposed on the main portion and located above the accommodating space in the up-down direction, a biasing member mounted to the fixed member, and a latch member pivotably connected to the fixed member and connected to the biasing member. The biasing member biases the latch member downwardly in the up-down direction. The brush unit includes a brush seat member, and a bristle member disposed on one side of the brush seat member that is opposite to the mount seat in the extending direction. The brush seat member includes a brush body portion detachably mounted in the accommodating space and connected to the mount seat by the latch member of the at least one fastener unit, and a strip portion connected to the brush body portion and detachably engaging the engage groove.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view of a quick release and assemble module of an embodiment according to the present disclosure and a shoe making machine.

FIG. 2 is an assembled perspective view of the embodiment.

FIG. 3 is a partly exploded perspective view of the embodiment.

FIG. 4 is another partly exploded perspective view of the embodiment seen from an angle different from FIG. 3.

FIG. 5 is a schematic front view of a mount seat and two fastener units of the embodiment.

FIG. 6 is a sectional view taken along line VI-VI in FIG. 5, illustrating two pogo pins of the mount seat.

FIG. 7 is a view similar to FIG. 6, but illustrating a plunger portion of each of the pogo pins being moved into a barrel portion of the pogo pin.

FIG. 8 is a sectional view taken along line VIII-VIII in FIG. 5, illustrating a latch member of the fastener units.

FIG. 9 is a sectional view similar to FIG. 8, but illustrating the latch member being moved upwardly.

FIG. 10 is a perspective view of the embodiment, illustrating a brush unit of the embodiment being inserted inclinedly into the mount seat.

FIG. 11 is a perspective view of the embodiment seen from an angle different from FIG. 10, illustrating the brush unit being inserted inclinedly into the mount seat.

FIG. 12 is a perspective view illustrating a modification of the embodiment, illustrating the quick release and assemble module of the embodiment including only one fastener unit.

FIG. 13 is a partly exploded perspective view of another modification of the embodiment.

FIG. 14 is a partly exploded perspective view of the another modification seen from an angle different from FIG. 13.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

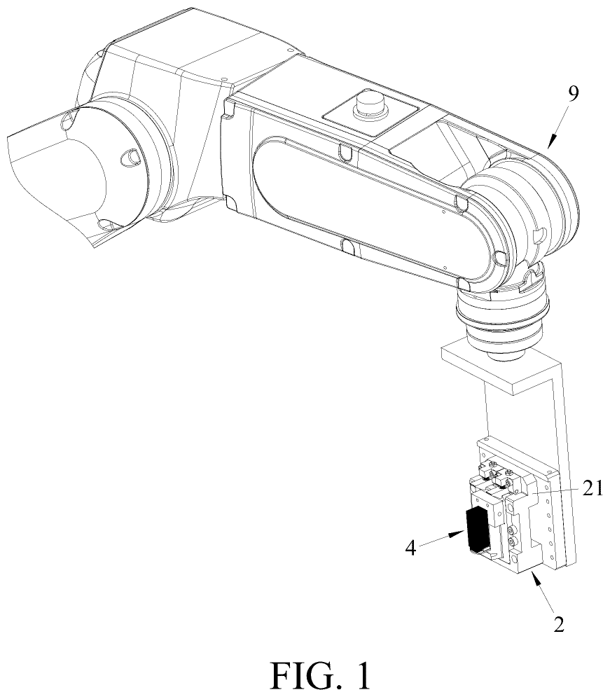

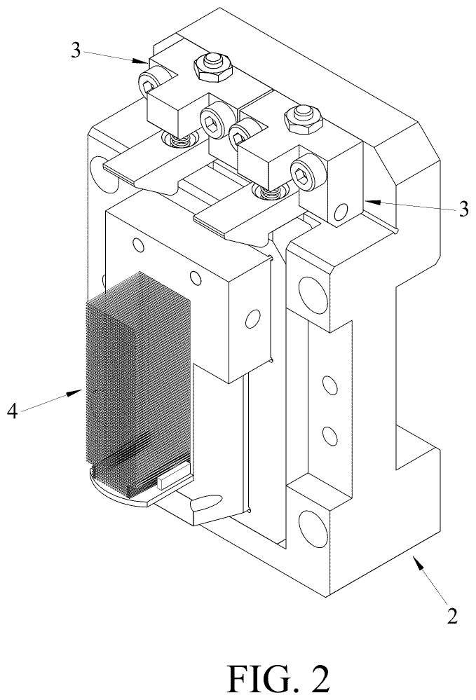

Referring to FIGS. 1 to 3, an embodiment of a quick release and assemble module according to the present disclosure is adapted to be used in a shoe making machine 9. The quick release and assemble module includes a mount seat 2, two fastener units 3, and a brush unit 4.

Referring to FIGS. 1, 3 and 4, the mount seat 2 includes a main portion 21 adapted to be mounted to the shoe making machine 9, a bottom portion 22 extending in an extending direction (X) from one side of the main portion 21 that is opposite to the shoe making machine 9 in the extending direction (X) and elongated in a horizontal direction (Y) transverse to the extending direction (X), an engage portion 23 extending upwardly in an up-down direction (Z) that is transverse to the horizontal direction (Y) and the extending direction (X) from one side of the bottom portion 22 in the horizontal direction (Y) and connected to the main portion 21, a side portion 24 extending upwardly in the up-down direction (Z) from another side of the bottom portion 22 in the horizontal direction (Y) and connected to the main portion 21, two positioning pins 25 extending upwardly from the bottom portion 22 in the up-down direction (Z), and two pogo pins 26 extending through the main portion 21 in the extending direction (X).

The main portion 21, the bottom portion 22, the engage portion 23 and the side portion 24 cooperatively define an accommodating space 27 open in a direction opposite to the shoe making machine 9 in the extending direction (X). The positioning pins 25 extend into the accommodating space 27.

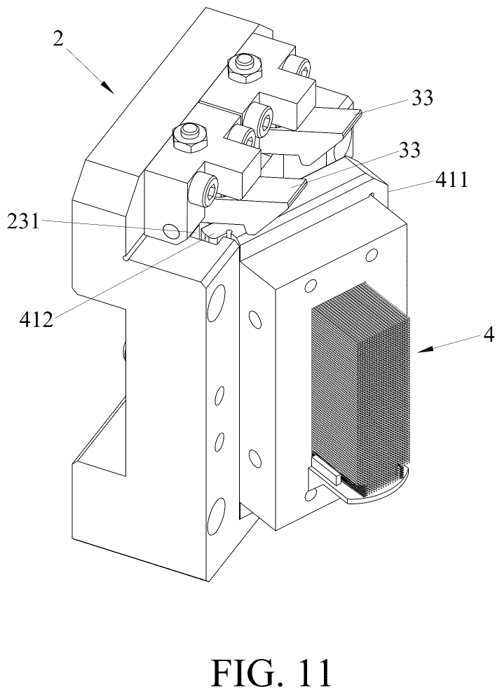

The engage portion 23 has an engage groove 231 in spatial communication with the accommodating space 27, extending in the up-down direction (Z), and opening upward (see FIG. 11).

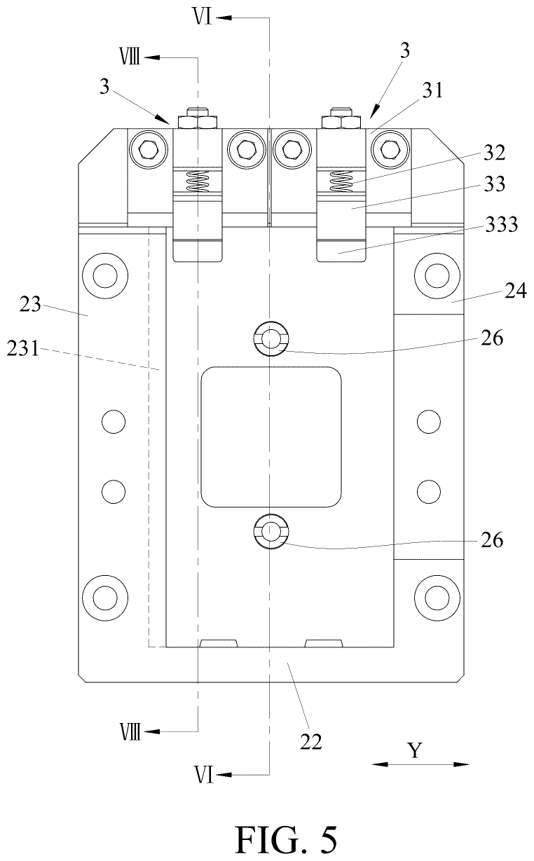

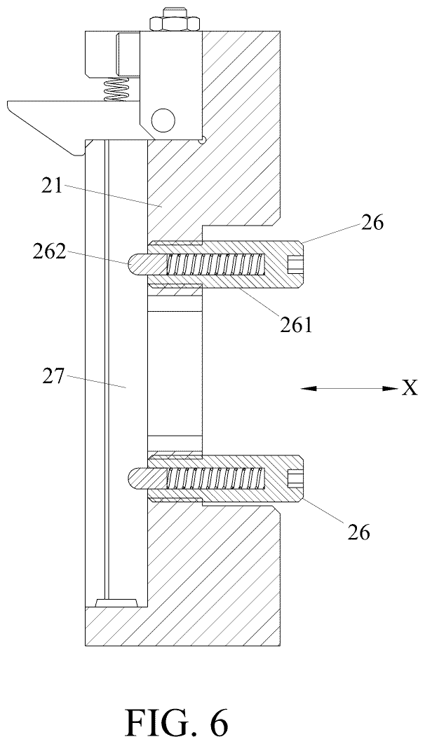

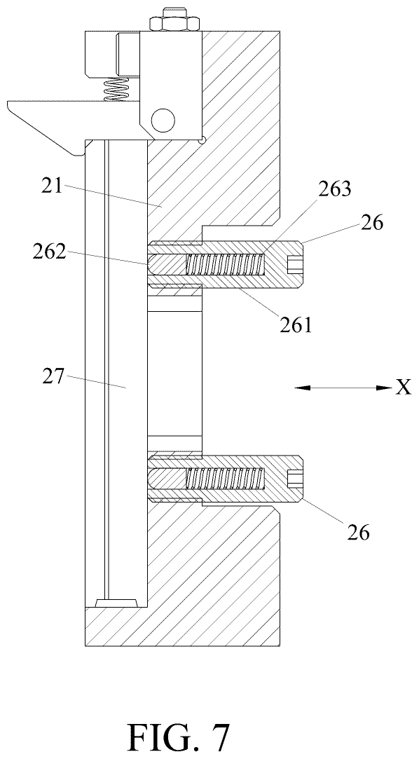

Referring to FIGS. 5 to 7, each of the pogo pins 26 includes a barrel portion 261 extending into the main portion 21, a plunger portion 262 disposed in the barrel portion 261 and movable relative to the barrel portion 261 in the extending direction (X), and an spring portion 263 connected between the barrel portion 261 and the plunger portion 262 and biasing the plunger portion 262 away from the barrel portion 261. For each of the pogo pins 26, the plunger portion 262 is pushed by the brush unit 4 to move relative to the barrel portion 261 in the extending direction (X). As shown in FIG. 6, for each of the pogo pins 26, the plunger portion 262 is biased away from the barrel portion 261 by the spring portion 263 and extends into the accommodating space 27 when not being pushed by the brush unit 4. On the contrary, as shown in FIG. 7, for each of the pogo pins 26, the plunger portion 262 is pushed by the brush unit 4 (not shown in FIG. 7) to gradually move into the barrel portion 261 in the extending direction (X).

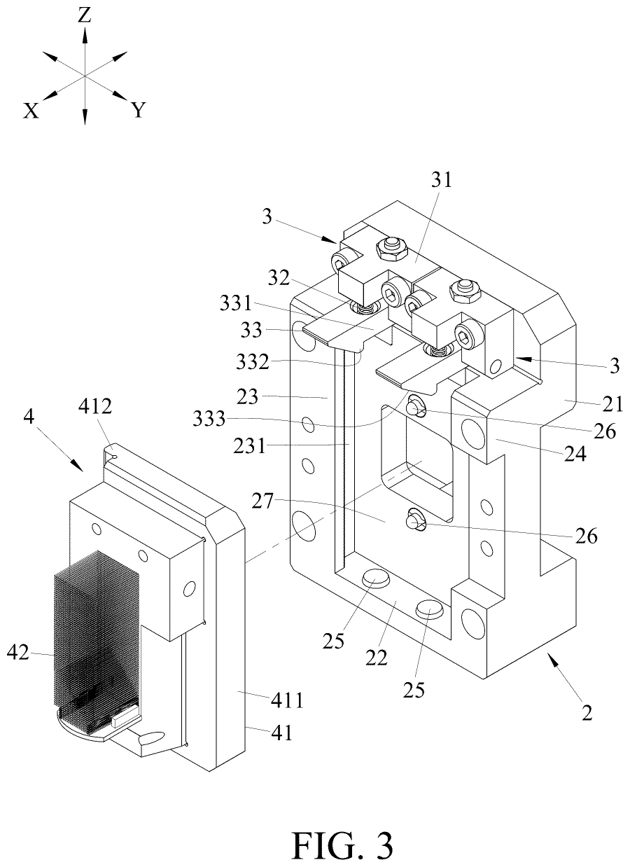

Referring to FIGS. 3 and 5, the fastener units 3 are disposed on the main portion 21 and are spaced apart from each other in the horizontal direction (Y). It should be noted that since the structures of the fastener units 3 are identical, in the following description, only one of the fastener units 3 will be described for the sake of brevity. The fastener unit 3 includes a fixed member 31 disposed on the main portion 21 and located above the accommodating space 27 in the up-down direction (Z), a biasing member 32 mounted to the fixed member 31, and a latch member 33 pivotably connected to the fixed member 31 and connected to the biasing member 32. In this embodiment, the latch member 33 is pivotable about an axis extending in the horizontal direction (Y). The biasing member 32 biases the latch member 33 downwardly in the up-down direction (Z). In this embodiment, the biasing member 32 is a compression spring.

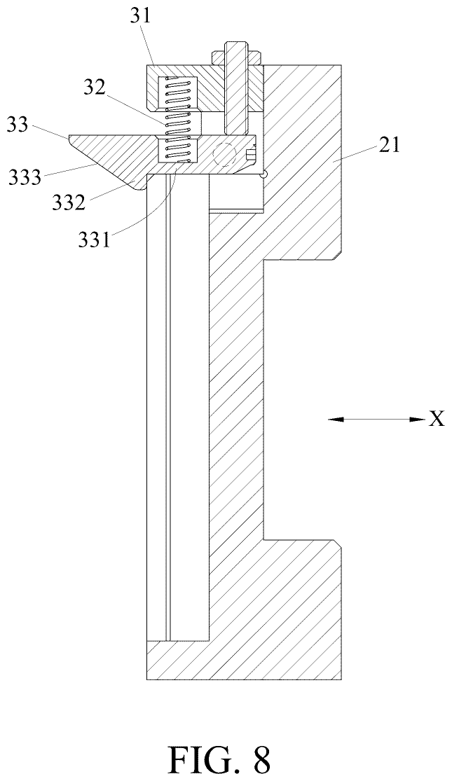

As shown in FIG. 8, the latch member 33 includes a pivotable portion 331 pivotably connected to the fixed member 31 and connected to a lower side of the biasing member 32 in the up-down direction (Z), and a block portion 332 connected to one side of the pivotable portion 331 that is opposite to the main portion 21 in the extending direction (X).

The block portion 332 has a lower end protruding downwardly in the up-down direction (Z), and an inclined surface 333 facing downwardly in the up-down direction (Z) and inclined toward the pivotable portion 331.

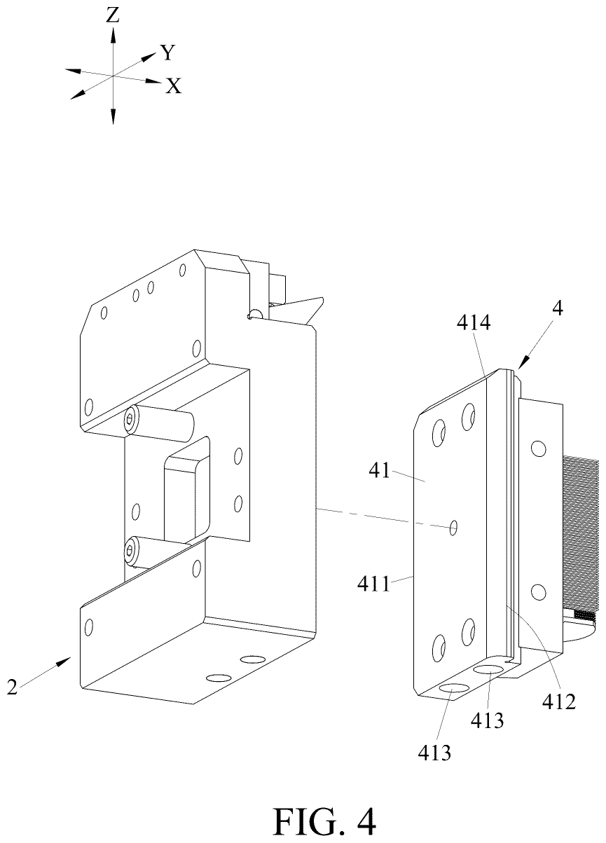

Referring to FIGS. 3 and 4, the brush unit 4 includes a brush seat member 41, and a bristle member 42 disposed on one side of the brush seat member 41 that is opposite to the mount seat 2 in the extending direction (X).

The brush seat member 41 includes a brush body portion 411 detachably mounted in the accommodating space 27 and connected to the mount seat 2 by the latch member 33 of the fastener unit 3, and a strip portion 412 connected to the brush body portion 411 and detachably engaging the engage groove 231. As shown in FIG. 4, the brush body portion 411 has two positioning holes 413 formed in a bottom part of the brush body portion 411 and for insertion of the positioning pins 25 therein, respectively, and a chamfered surface 414. The chamfered surface 414 is located at a junction between one side of the brush body portion 411 that is opposite to the bristle member 42 in the extending direction (X) and a top side of the brush body portion 411 in the up-down direction (Z). The chamfered surface 414 cooperates with the inclined surface 333 of the latch member 33 to guide the brush unit 4 to be smoothly moved into and engage the accommodating space 27. In this embodiment, the bristle member 42 includes a plurality of brush bristles for applying the adhesive.

In this embodiment, the amounts of the fastener units 3, the positioning pins 25, the pogo pins 26 and the positioning holes 413 are two, but the present disclosure is not limited herein. That is to say, in other embodiments, the amounts of the fastener unit 3, the positioning pin 25, the pogo pin 26 and the positioning hole 413 may be one or more than two.

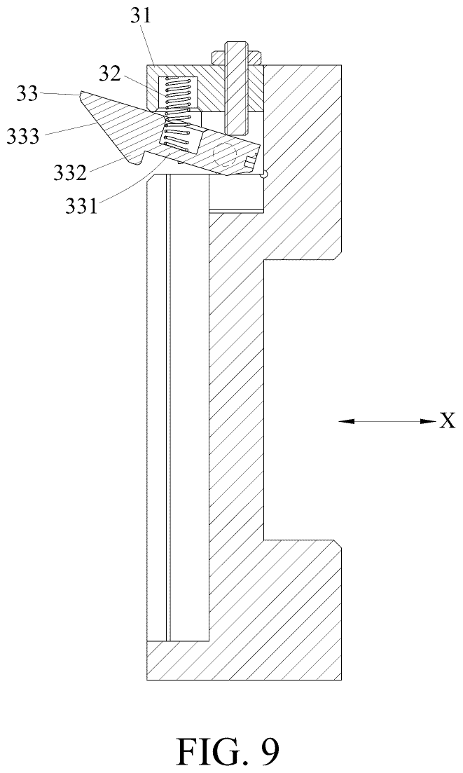

Referring to FIGS. 3, 8 and 9, the latch member 33 of the fastener unit 3 may be moved upwardly and pivot relative to the fixed member 31. As shown in FIG. 8, when the latch member 33 is not moved by an external force, the latch member 33 is biased downwardly by the biasing member 32. In this embodiment, the latch member 33 has a pivot end opposite to the block portion 332 in the extending direction (X) and abutting against a bolt that extends in the up-down direction (Z) and that is connected fixedly to the fixed member 31 such that the latch member 33 is substantially horizontal when the latch member 33 is not moved. Turning to FIG. 9, when the latch member 33 is moved upwardly, the block portion 332 pivots relative to the fixed member 31 such that the biasing member 32 is bent.

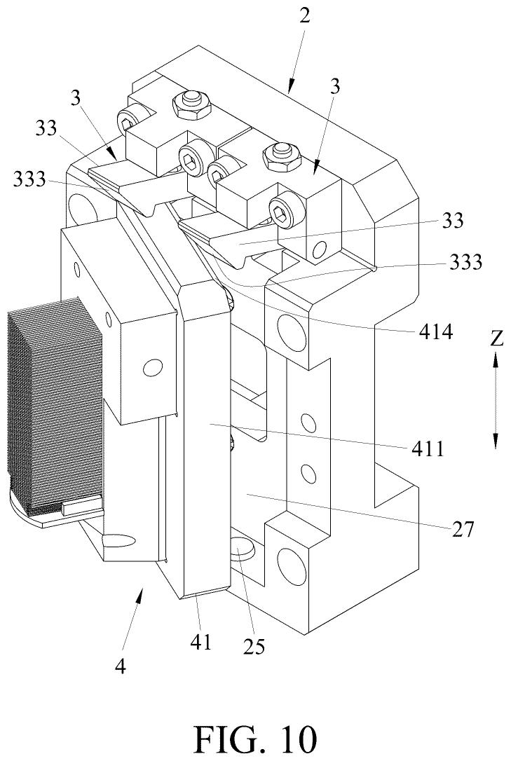

With reference to FIGS. 3, 10 and 11, when it is desired to mount the brush unit 4 to the mount seat 2, one of the latch members 33 of the fastener units 3 that is proximate to the engage groove 231 is moved upwardly in the up-down direction (Z) so that a portion of the strip portion 412 is inserted into the engage groove 231 at an inclined angle, and the top side of the brush body portion 411 is disposed below the one of the latch members 33 with the bottom part of the brush body portion 411 located above the positioning pins 25 in the up-down direction (Z). Then, the other one of the latch members 33 that is away from the engage groove 231 is moved upwardly through a direct upward pulling or movement of the chamfered surface 414 of the brush seat member 41 along the inclined surfaces 333 of the latch members 33. In this way, the brush seat member 41 of the brush unit 4 is guided to be smoothly moved into and engage the accommodating space 27, thus pushing the plunger portion 262 of each of the pogo pins 26 into the barrel portion 261 and the brush seat member 41 comes into contact with the main portion 21 of the mount seat 2.

The brush unit 4 is then moved downwardly toward the bottom portion 22 of the mount seat 2 so the positioning holes 413 respectively engage into the positioning pins 25 of the mount seat 2. At the same time, the latch members 33 are biased by the biasing members 32 to move downwardly to the position shown in FIG. 8 so that the block portions 332 of the latch members 33 engage the top side of the brush seat member 41, and the brush unit 4 becomes connected to the mount seat 2.

Since movement of the brush unit 4 is restricted by the latch members 33 and the positioning pins 25, the brush unit 4 may be stably mounted to the mount seat 2.

To detach the brush unit 4 from the mount seat 2, the latch members 33 are first moved upwardly, the brush unit 4 is also moved upwardly so the positioning holes 413 disengage from the positioning pins 25, and the plunger portions 262 of the pogo pins 26 are biased by the spring portions 263 of the pogo pins 26 to extend into the accommodating space 27 and push the brush unit 4 away from the mount seat 2 so that the brush unit 4 disengages from the accommodating space 27 to complete the detachment of the brush unit 4.

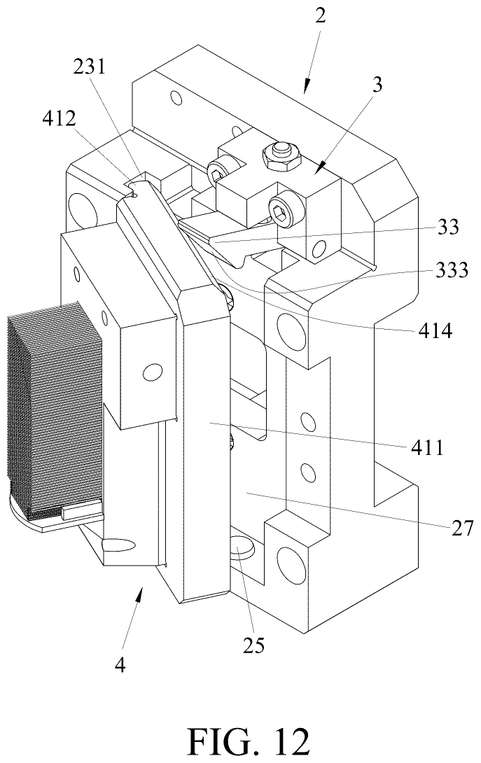

In a modification of the embodiment, referring to FIG. 12, the quick release and assemble module includes only one fastener unit 3. In this modification, the strip portion 412 may be directly inserted into the engage groove 231 at an inclined angle to mount the brush unit 4 to the mount seat 2, and the modification also achieves the same effect of quick release and assemble of the brush unit 4.

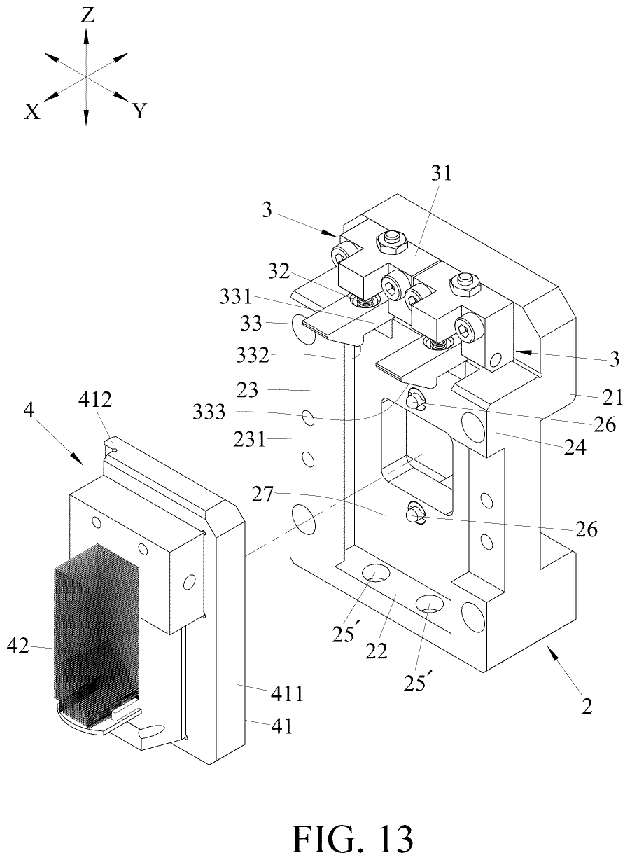

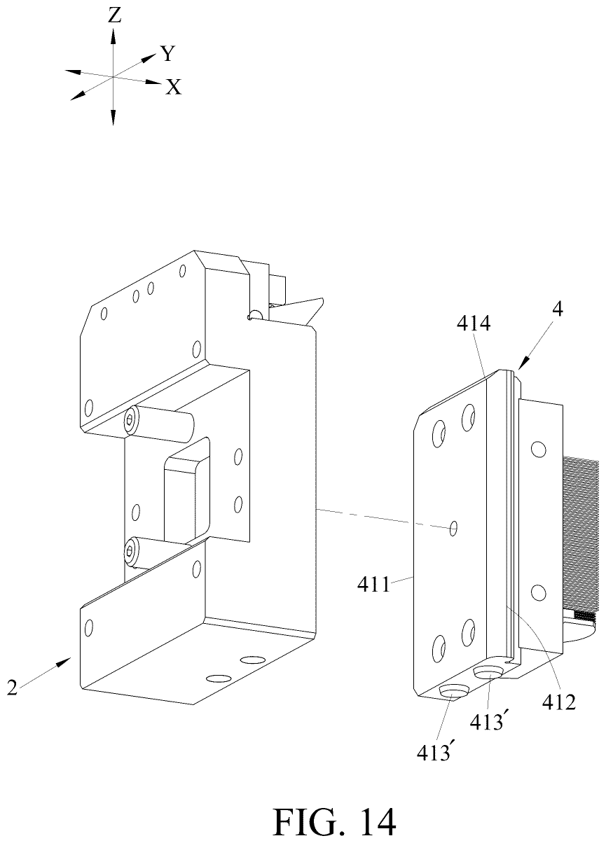

Referring to FIGS. 13 and 14, another modification of the embodiment is shown. It should be noted that the positioning pins 25 (see FIGS. 3 and 4) of the mount seat 2 and the positioning holes 413 of the brush body portion 411 are omitted in this modification. In this modification, the brush body portion 411 has two positioning pins 413′ extending downwardly from the bottom part of the brush body portion 411 in the up-down direction (Z) and the bottom portion 22 of the mount seat 2 has two positioning holes 25′ facing downwardly, in spatial communication with the accommodating space 27, and for insertion of the positioning pins 413′ therein, respectively. In this way, this modification also provides the same effect as the embodiment shown in FIGS. 1 to 12. It should be noted that the configurations of the positioning holes 25′ and the positioning pins 413′ may be modified as long as the mount seat 2 and the brush unit 4 are connected through engagement thereamong.

It should be further noted that the quick release and assemble module of the present disclosure may be utilized in a shoe making machine that is capable of automatically replacing the brush unit 4 for various shoe types. For example, a first robotic arm (not shown) is provided for moving the latch member(s) 33 upwardly and a second robotic arm (not shown) is provided for clamping and moving the brush unit 4 such that when the brush unit 4 is to be replaced, after the first robotic arm moves the latch member(s) 33 upwardly, the brush unit 4 is first moved upwardly by the second robotic arm, is pushed out of the accommodating space 27 by the plunger portions 262 of the pogo pins 26, and then is moved away from the mount seat 2 by the second robotic arm. A third robotic arm (not shown) is provided to clamp another brush unit for replacement and insert the same into the accommodating space 27. Finally, the first robotic arm releases the latch member(s) 33 to fasten the another brush unit to the mount seat 2 for replacement. It should be noted that, in some embodiments, the positioning pins 25 and 413′ and the positioning holes 413 and 25′ may be omitted to facilitate replacement of the brush unit 4.

In summary, by virtue of the structures of the engage groove 231 of the engage portion 23, the strip portion 412 of the brush seat member 41 that detachably engages the engage groove 231, the latch members 33 that detachably fasten the brush body portion 411 to the mount seat 2, and the positioning pins 25 and 413′ that detachably engage the positioning holes 413 and 25′, the brush unit 4 may be quickly assembled to and detached from the mount seat 2 without using screws. Thus, it is convenient to replace different brush units for various shoe types in the shoe making machine 9 using the quick release and assemble module of the present disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A quick release and assemble module adapted to be used in a shoe making machine, said quick release and assemble module comprising:
a mount seat that includes a main portion adapted to be mounted to the shoe making machine, a bottom portion extending in an extending direction from one side of said main portion opposite to said shoe making machine in the extending direction and elongated in a horizontal direction transverse to the extending direction, an engage portion extending upwardly in an up-down direction that is transverse to the horizontal direction and the extending direction from one side of said bottom portion in the horizontal direction and connected to said main portion, and a side portion extending upwardly in the up-down direction from another side of said bottom portion in the horizontal direction and connected to said main portion, said main portion, said bottom portion, said engage portion and said side portion cooperatively defining an accommodating space that is open in a direction opposite to said shoe making machine in the extending direction, said engage portion having an engage groove in spatial communication with said accommodating space, extending in the up-down direction, and opening upward;
at least one fastener unit that includes a fixed member disposed on said main portion and located above said accommodating space in the up-down direction, a biasing member mounted to said fixed member, and a latch member pivotably connected to said fixed member and connected to said biasing member, said biasing member biasing said latch member downwardly in the up-down direction; and
a brush unit that includes a brush seat member and a bristle member disposed on one side of said brush seat member that is opposite to said mount seat in the extending direction, said brush seat member including a brush body portion detachably mounted in said accommodating space and connected to said mount seat by said latch member of said at least one fastener unit, and a strip portion connected to said brush body portion and detachably engaging said engage groove.

2. The quick release and assemble module as claimed in claim 1, wherein said latch member of said at least one fastener unit includes a pivotable portion pivotably connected to said fixed member and connected to a lower side of said biasing member in the up-down direction, and a block portion connected to one side of said pivotable portion that is opposite to said main portion in the extending direction, said block portion having a lower end protruding downwardly in the up-down direction.

3. The quick release and assemble module as claimed in claim 2, wherein said block portion of said at least one fastener unit has an inclined surface facing downwardly in the up-down direction and inclined toward said pivotable portion.

4. The quick release and assemble module as claimed in claim 1, wherein:
said mount seat further includes at least one positioning pin extending upwardly from said bottom portion in the up-down direction and extending into said accommodating space; and
said brush body portion has at least one positioning hole formed in a bottom part of said brush body portion and for insertion of said at least one positioning pin therein.

5. The quick release and assemble module as claimed in claim 1, wherein:
said brush body portion has at least one positioning pin extending downwardly from a bottom part of said brush body portion; and
said bottom portion of said mount seat has at least one positioning hole facing downwardly in the up-down direction, in spatial communication with said accommodating space, and for insertion of said at least one positioning pin therein.

6. The quick release and assemble module as claimed in claim 1, wherein:
said mount seat further includes at least one pogo pin extending through said main portion, including a barrel portion that extends into said main portion, and a plunger portion that is disposed in said barrel portion, and that is movable relative to said barrel portion in the extending direction;
when said brush body portion is detached from said mount seat, said plunger portion extends into said accommodating space; and
when said brush body portion is connected to said mount seat, said plunger portion is pushed by said brush body portion to gradually move into said barrel portion in the extending direction.

7. The quick release and assemble module as claimed in claim 1, wherein said at least one fastener unit includes two fastener units disposed on said main portion and spaced apart from each other in the horizontal direction.

8. The quick release and assemble module as claimed in claim 1, wherein said biasing member of said at least one fastener unit is a spring.

9. The quick release and assemble module as claimed in claim 3, wherein said brush body portion has a chamfered surface, said chamfered surface being located at a junction between one side of said brush body portion that is opposite to said bristle member in the extending direction and a top side of said brush body portion in the up-down direction, and cooperating with said inclined surface of said at least one fastener unit to guide said brush unit to be smoothly moved into and engage said accommodating space.
